(19) United States
(12) Patent Application Publication
(10) Pub. No.: US 2018/0053255 A1
(43) Pub. Date: Feb. 22, 2018

(54) System and Method for end to end investment and portfolio management using machine driven analysis of the market against qualifying factors

(71) Applicants: Shankar Valdyanathan, Sammamish, WA (US); Srirama Krishnakumar, Sammamish, WA (US)

(72) Inventors: Shankar Valdyanathan, Sammamish, WA (US); Srirama Krishnakumar, Sammamish, WA (US)

(73) Assignee: Noonum, Sammamish, WA (US)

(21) Appl. No.: 15/241,065

(22) Filed: Aug. 19, 2016

(51) Int. Cl. G06Q 40/06; G06Q 10/06; G06Q 40/04; G06Q 50/00

(52) U.S. Cl. CPC G06Q 40/06; G06Q 50/01; G06Q 40/04; G06Q 10/067

(57) ABSTRACT

Device, system, and method to perform analysis of asset values and factors, predict the future prices of assets, provide recommendations, and preform actions. A method may include analyzing and forecasting the performance of at least one asset against one or more impacting factors. A financial asset includes, but not limited to a company stock price and asset factors include revenue, sales, EBITDA etc. The impacting factors include, but not limited to a comprehensive set of structured and un-structured data such as SEC filings, company reports, business graphs, news and social media, and economic and non-economic indicators. The method includes causation factors identified through a business or enterprise graph, wherein the nodes of the graph represent businesses/enterprises/companies, and the edges represent various relationships between the nodes including, but not limited to, supply-chain, partners, cash flow, and competition. System supports method to provide recommendations based on the analysis and forecast and subsequently take actions based on the recommendations. The method employs self-learning deep machine learning techniques that eliminate human bias, emotions, and conflicts of interest.

### DESCRIPTION OF THE RELATED ART

Financial analysis is a core process adopted by wealth, hedge-fund, portfolio managers, and stock and industry analysts for accumulation of economic wealth by identifying investment opportunities, thereby selling/buying stocks, bonds, and commodities. Most of the financial institutions do this analysis in-house. A typical analysis might include measuring the impact to a portfolio due to an interest rate hike or forecasting the changes to the revenue or profitability of a company due to a reduction in capital expenditure or marketing spending. This type of analysis, sometimes known as “What If” analysis, would typically include the ingestion of data (both market data and also data on economic indicators), cleansing and combining of data including missing values, making appropriate adjustments for seasonality, dollar exchange rate, etc., appropriately forecasting key elements, building and running models against the data, identifying the best/appropriate fit from the runs, processing the necessary results, and finally taking action on the data including buy/sell on the stock or its derivatives. The current state of the art is that all these comprehensive set of activities are done individually in each company or financial institution with custom software and applications. Although there are many data providers including Bloomberg and Federal Reserve, there is no well-defined/featured platform/service that benefits thousands of customers and institutions.

### BRIEF SUMMARY OF INVENTION

The invention is a comprehensive end to end investment and portfolio management system with an emphasis on a completely machine driven financial analysis. Company fundamentals such as revenue, profit, along with the prices of its stocks, bonds etc. is projected using a rich set of up to date indicators including financial, economic, and demographic, ingested from a variety of disparate data sources around the globe. The analysis is not limited to individual companies and is used for analyzing and projecting the performance of various sectors, industries, verticals, portfolios etc. The analysis also includes but not limited to projections of economic indicators (e.g. GDP of a country, employment rate), commodities, and demographic variables given appropriate data sets. The analysis is further strengthened using a novel business graph representing various relationships across enterprises, individuals, commodities etc. that are derived by analyzing information sources on supply-chain, cash flow, and competition. Based on the analysis and forecasting, the system provides recommendations and a set of actions for the user. The system is capable of operating in auto-pilot mode across all these operations.

### BRIEF DESCRIPTION OF DRAWINGS

FIG. 1 shows the multitude of signals that are ingested by the system to perform analysis, forecasting, recommendations, and actions.

FIG. 2 shows the logical flow of data and the sequence of operations in the system. The physical architecture of the system closely resembles the logical system.

FIG. 3 portrays a representation of the Business Graph wherein the nodes are companies and the edges represent either supply-chain relationship or competition. The system determined weights of the supply-chain relationship are also marked above the edges.

FIG. 4 is an embodiment for the functionality of user modifications to the system generated forecasts. Time T is the current time. T+1 and T+2 are units of time in future of the current time. These units of time are typically one of days, months, years, etc. The system generated forecast values are shown as non-shaded triangles that can be moved along a slider in the vertical direction by the user. The user changes to the system's forecasts are shown as shaded triangles.

### DETAILED DESCRIPTION OF THE INVENTION

In general form, this invention is a system, method, and apparatus to allow users to measure, forecast, and obtain insights for a selectable set of variables/features against another set of variables/features.

As an example, let's suppose we feed this system with a series of numbers, say 1 to 5 as variable X, and its squares, namely, 1, 4, 9, 16, and 25, as variable Y. Now if we ask the system what would be the value of Y if X happens to be 10, it is likely to produce an answer that lies between 99 and 101. This system was never told that the relationship between the two variables is square, but the system understood the relationship and automatically computed the range of the answer for the new number 10 with some confidence.

In the real world, this system is used not to mimic a calculator, but the variables/features are potentially market data on stocks and bonds, economic indicators such as GDP and Consumer Price Index, and other time-series variables such as population growth and mobile usage. With variables like exchange rates and crude oil price, this system helps with the impact analysis and prediction of stock prices. Similarly, it helps measure the change in income/profit of a company given the proposed changes to its capital expense spending or its marketing budget.

This invention is such a system to perform experiments in the field of financial analysis and enterprise risk management where the impact on a portfolio based on changes in the value of key financial and economic factors such as strengthening of the US dollar, changes in GDP of key countries, falling crude oil price etc. need to be understood.

This system offers a service that demystifies and brings financial analysis within the easy reach of the investment masses ranging all the way from individual retail investors to sophisticated institutional investors, and thereby, democratizes this art/science.

This invention is machine driven without any human bias allowing for emotion-free investment decisions. This invention uses self-learning deep machine learning models that are non-linear, thus radically shifting from traditional (popular known as technical analysis) statistically driven models. The attached computer listing contains computer source code as one possible embodiment employing a neural net model to accurately understand and predict the impact of key economic indicators on S&P 500 index price. This source code is in language R.

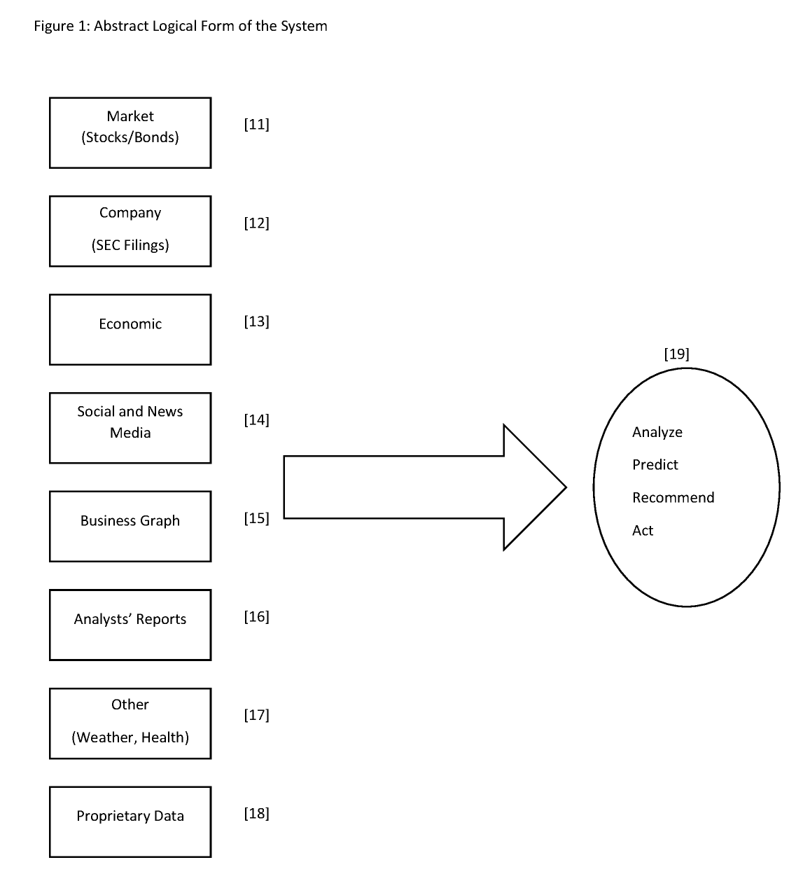

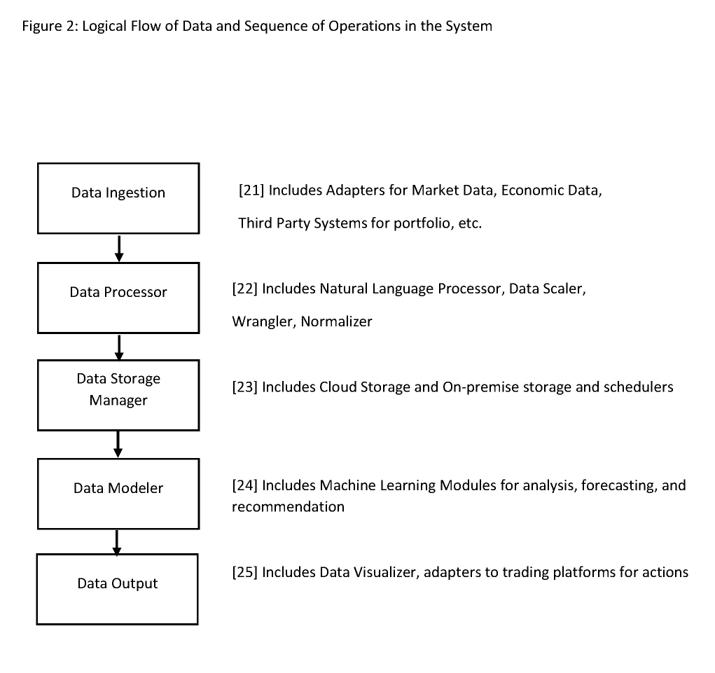

This invention has a categorized palette of signals to choose from for the financial analysis. The signals include, but not limited to market data as shown in box 11 in FIG. 1, company SEC filings (10K/10Q) as shown in box 12 in FIG. 2, economic indicators from around the world as shown in box 13 in FIG. 1, general data including weather, health, and demographics as shown in box 17 in FIG. 1, unstructured data from social and news media as shown in box 14 in FIG. 1, as well as analyst reports as shown in box 16 in FIG. 1. Signals include economic and market data from developed, emerging, and frontier markets as well.

This invention has provisions to bring in proprietary data through the BYOD (Bring Your Own Data) module, as shown in box 18 of FIG. 1. The proprietary user data is operated in an isolated data lake/enclave for maximum security and privacy.

The system also identifies the right set of qualifying indicators that affect a particular security or a particular company fundamental from the multitude of available signals shown in FIG. 1.

This invention has a very intuitive Natural User Interface (NUI) incorporating text, speech and voice. The mobile/tablet friendly user interface works well with touch and mouse allowing the user to drag and drop data sources to be included in the model.

This invention offers connectivity to major brokers including Ameritrade, Fidelity, Interactive Brokers, and Schwab for importing portfolios for analysis. In addition, this invention offers connectivity to algorithmic trading platforms to trigger actions on sells and buys, as shown in Box 21 of FIG. 2.

This invention supports popular models such as the basic Fama-French 3 factor model, Efficient Frontier model etc. for comparison purposes.

This invention allows sophisticated and premium users to swap out or introduce new models into the system for analysis through BYOA (Bring Your Own Algorithm) module. Such modules or submodules will replace box 24 of FIG. 2. In addition, premium users have command line interfaces to specify inclusion of specific data sources and specific models using a declarative language.

This invention allows data to be filtered along many dimensions including sectors, industries, and verticals.

This invention keeps data fresh at all points of time. All the data are available in a canonical form that can readily be used in models—such as the dates in unified form, special handling of missing data, and automatically selecting appropriate date ranges. In addition, the data is also wrangled (mapped or converted) so that the features are dollar and seasonally adjusted if necessary. The data sets are in appropriate units, and are scaled and normalized.

This invention provides integration with leading ERP solutions such as SalesForce and Microsoft Dynamics for easy import/export of corporate/enterprise data.

This invention provides integration with social sites including Facebook, Twitter, and Linkedin.

This invention is a service that is operated either customer or user's computers (e.g. a private cloud) or a public cloud infrastructure.

This invention allows sharing of the results of the model.

### DETAILED DESCRIPTION OF THE BUSINESS GRAPH

This invention generates, maintains, and evolves a business graph describing companies and the relationship between them. The nodes represent entities such as companies, individuals, commodities etc. The relationship between the nodes are represented as edges. The nodes and edges are named, and they consist of a property bag of information describing them. For instance, the property bags of the company nodes contain detailed information about the company, its name, its location, its revenue and profit, and its balance sheets for several years. Each property in the property bag contains additional meta-property fields such as the source of this information and the confidence associated with that source.

The graph is layered in the sense that there are multiple types of edges between nodes—one indicating supply-chain, another representing cash-flow information, the third one on competition, etc. Another possibility of edge between company nodes is correlation between its stock price movements, and thus this business graph is a complete graph.

The edges are weighted.

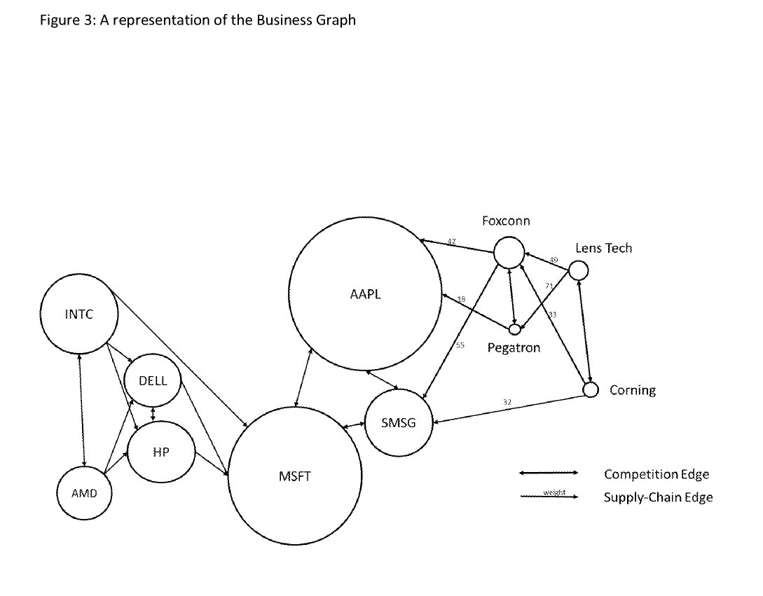

The above is illustrated in FIG. 3.

The ability to logically group the nodes of the graph is a basic notion of this business graph. The companies belonging to a particular industry/sector belong to an appropriate group, and thus one embodiment of the business graph contains the Technology group, Manufacturing group, etc. It is important to note that the nodes can belong to a multiple of these logical groups. As an example, a company node for Intel belongs both to a technology group and a semi-conductor group. In addition to containing nodes, these groups themselves can contain other groups, resulting in group of groups. It is also important to understand that the membership of nodes to groups changes over time.

Needless to say, there can be multiple graphs, and there are ways to merge many graphs into one, and so there are ways to split a single graph into multiple ones. Such collusion of graphs can be done across several different companies building this graph as long as they are built with the canonical specifications.

There are various ways to build this graph. The preferred embodiment is through novel machine learning techniques parsing various structured information sources including SEC filings, stock market feeds, economic indicators, etc. and also through unstructured data such as company reports, PR newswire, analyst reports, social and news media. For instance, to build the supply-chain edges, the system parses publicly available information such as company reports, PR newswire, analyst reports, and news media for customers of a particular company. Reversing the customer edge provides the supplier edge.

In one simple embodiment, the system looks for pairs of company names appearing together in the aforementioned information sources. Positive sentiment between the companies indicate potential supply chain and negative sentiment denotes competition. This is a brute force method.

In another embodiment, the electronic versions of service manuals are downloaded, and all the parts with their part numbers and sometimes its suppliers are obtained from them. If supplier information is not available, the manufacturers of those parts are identified through other means to build the graph.

In another embodiment, a generic graph is built for any particular industry with the help of professionals such as industry analysts and manufacturing experts. For instance, consider the mobile phone technology—mobile phone has a screen, battery, CPU, etc. Further, these first level of components are de-componentized to the next level and probably one more level after that. With this generic graph, all the potential manufacturers, contractors, and vendors of each component are identified. At this stage, there is not enough information to understand who supplies to who, but all the major players for each component are clearly identified. The graph is then completed by adopting a brute force method described above.

In another embodiment, edges of the graph also represent the correlation coefficient (such as Pearson's) of the corresponding nodes. A variation of this embodiment applies partial correlation aspects as well.

The source of the information for the graph is maintained in meta-property fields so that the information is verifiable at any point of time. The confidence factor of the accrued information is also maintained so that it is accounted in calculations and for decision making.

The graph is live, and it is continuously updated with the latest available information. The system's crawler continuously keeps the graph up to date. In addition, the technical community is engaged to check the factual information on the nodes and edges and provide with updated information which is then committed into the graph through a simple process. Such crowd-sourcing efforts to build and maintain this graph is a key factor to keep this graph fresh and relevant.

The system is also flexible to allow users to define their own edges and node types to augment the underlying business graph.

The stock market movement is due to several causative factors that happen in the marketplace. Factors such as drop in the price of a dollar are causative in increasing the stock price of export oriented companies that benefit from a lower dollar. A drop in price of crude oil decreases the stock price of companies such as Exxon Mobil that are reliant on the price of crude oil. Methods applied for the financial analysis with the help of the business graph facilitates appropriate investment decisions. As a more detailed example, with the help of the business graph, one sees the cascading impact of an increase in silicon prices to Lens Technology (http://www.nytimes.com/2015/08/02/business/international/how-zhou-qunfei-a-chinese-billionaire-built-her-fortune.html?_r=0), then to Foxconn (http://recode.net/2015/04/06/where-apple-products-are-born-a-rare-glimpse-inside-foxconns-factory-gates/), and eventually to Apple (AAPL). The market takes time to react to these cascading changes across the globe, and hence the retail and institutional investors using the system's business graph can make wise investment decisions potentially faster than the time it takes for the market reaction. This ability provides a competitive edge to the users of our system.

Given the nodes of the system's business graph are entities, the system's business graph can be connected to the social graphs of Facebook or Linkedin. The unique ability of the system is to deduce relationships that were not easily identifiable earlier.

In such a combined and synergetic world, the nodes also represent prominent individuals (e.g. Carl Icahn, Warren Buffet) and commodities (e.g. natural resources such as oil, precious metals, and agricultural ones such as cotton, wheat etc.)

Another embodiment of the nodes is financial entities such as ETFs and Mutual Funds, and the edges drawn between them and other company nodes provide a rich representation of the investment world.

One of the key capabilities of the system is to improve the ability to understand the impact and forecasting abilities of the company's fundamentals and stock prices with a wide variety of signals shown in FIG. 1. One measure of our predictive power is measured through the Mean Square Error (MSE) from the back-testing.

In terms of actual prediction techniques, there are some novel ways that we do the prediction as described below: 1-layer, 2-layer, hybrid-layer.

The premise behind the 1-layer prediction is based on the belief that today's market was a result of the past economic conditions. So the model is trained with a historical time series of market prices against the variety of signals whose timestamps lag behind by a canonical time period. While this lag period is user-defined, it is also automatically determined by running the model against various time periods and identifying the one with the least error. Given this approach, the future market prices are simply predicted based on the current impacting factors such as the economic indicators.

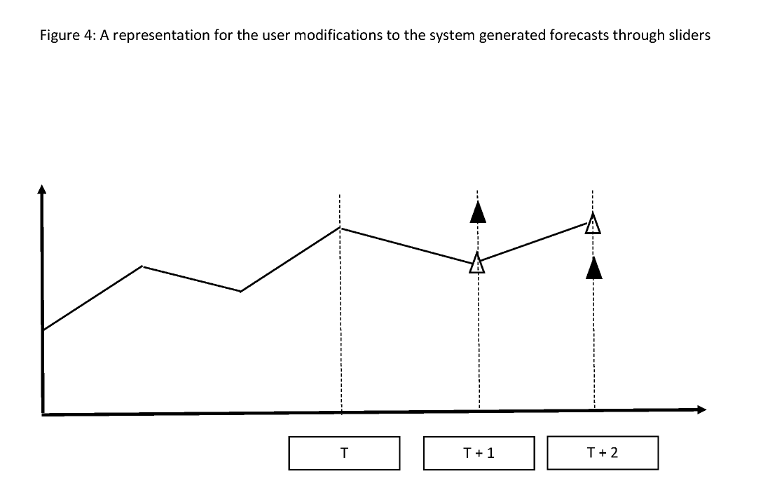

The premise behind the 2-layer prediction is based on the belief that the economy and the stock market move in synchronization. So the model is trained with a historical time series of market prices against the variety of signals that also have the same timestamp. So in order to predict the future price movements, the impacting factors such as the economic indicators are predicted first. Then the price of the asset is predicted based on the predictions of the impacting factors. The system is thus able to provide the ability to the user to modify the machine generated predictions with their own intuitions or predictions. The system has provisions to download the economic predictions available publicly from Moody's and others and employ them in lieu of system predicted values. The market movement is then predicted based on the new set of values. The flexibility and the power of system that allows the users to bring their own predictions or modify the machine generated predictions to understand and measure the market movement of the price of an asset or assets is a first of its kind commercial service offering. This is shown in FIG. 4.

The preferred embodiment does not allow the user in 1-layer model the option to bring their own intuition. However, the system allows users to input their intuition in their form of changing the values of predicted values. The system allows a third method—a hybrid model that allows the users to bring in their own intuition with certain bounds. With the hybrid model, the operating philosophy is that today's market is not only dependent on today's economic conditions but also on the past. So the model is trained with a historical time series of market prices against a variety of signals whose timestamps have the same timestamp as the market, in addition to the ones in the past. In one embodiment, the hybrid prediction model of the system provides the users with sliders to input their prediction to any impacting factor as shown in FIG. 4. At the same time, the novelty of the hybrid system provides a much required level of protection to users' unintended errors to their predictions.

We have identified that given a set of assets, the system is capable of an extensive analysis including bringing in the causation factors. Based on the causative factors the system recommends appropriate rebalancing or hedging strategies so that the overall risk of the portfolio is reduced.

An example of a rebalancing strategy is outlined here. If the system observes that certain assets within a portfolio are negatively correlated, it recommends a rebalancing strategy. Consider an asset such as Amazon (AMZN) stock that has exhibited negative correlation with another asset such as Best Buy (BBY), then the system recommends buying AMZN stock to offset BBY risk. Another example is to sell Exxon Mobile (XOM) stock to offset exposure to crude oil risk in the portfolio. In this case the system used the causative information on crude oil being the biggest supplier for Exxon Mobile and price movements in crude oil have a material effect on Exxon Stock. The system recommends the number of stocks to be bought or sold short in order to rebalance the portfolio.

The system recommends an appropriate hedging strategy for assets within the portfolio based on causative correlation that is observed in the marketplace outside of the portfolio. A few examples of hedging strategies are to buy or sell futures contracts on commodities, currencies etc. In addition, the system recommends the number of such contracts to be bought or sold.

In some cases, customers of the system are restricted from operating in certain markets or taking on short positions. In these cases, the system makes recommendations that are in compliance with the customer's needs. An example of such an instance is to buy an ETF asset such as TMV to hedge the risk of T-Bond exposure.

The system allows the user take actions on these recommendations. The system interfaces with trading platforms, brokerages, and portfolio management software solutions like Fidelity, Interactive Brokers, etc. to help with taking actions such as trades on the system's recommendations. This is shown in box 25 in FIG. 2. This system operates on autonomously by demand. In one embodiment, given a portfolio, the system automatically analyzes the signals such as economic factors, provides recommendations, and takes action based on these recommendations. So just like how self-driving cars can monitor and operate itself according to the traffic conditions and reach a canonical destination, this system can monitor a portfolio and analyze the economic conditions and company fundamentals, make forecasts, provide periodic recommendations, and take appropriate trading actions to get the user to the target return expectations.

### PATENT CITATIONS

Lee, et al. Stock analysis method, computer program product, and computer-readable recording medium. U.S. Pat. No. 8,712,897. Apr. 29, 2014.
Herz, et al. Stock market prediction using natural language processing. U.S. Pat. No. 8,285,619. Oct. 9, 2012.
Madhavan, et al. Factor risk model based system, method, and computer program product for generating risk forecasts. U.S. Pat. No. 8,019,670, Sep. 13, 2011.
Jones, et al. Financial advisory system. U.S. Pat. No. 6,021,397. Feb. 1, 2000.
Robinson, Automated portfolio selection system. U.S. Pat. No. 6,484,152. Nov. 19, 2002.

### NON-PATENT CITATIONS

Markowitz, H. M. (March 1952). “Portfolio Selection”. The Journal of Finance. 7 (1): 77-91.
Merton, Robert. (September 1972). “An analytic derivation of the efficient portfolio frontier,” Journal of Financial and Quantitative Analysis. 1851-1872.
Low, R. K. Y.; Faff, R.; Aas, K. (2016). “Enhancing mean—variance portfolio selection by modeling distributional asymmetries”. Journal of Economics and Business.
Taleb, Nassim Nicholas (2007), The Black Swan: The Impact of the Highly Improbable, Random House.
Fama, E. F.; French, K. R. (1993). “Common risk factors in the returns on stocks and bonds”. Journal of Financial Economics. 33: 3.
Fama, E. F.; French, K. R. (1992). “The Cross-Section of Expected Stock Returns”. The Journal of Finance. 47 (2): 427.
Fama, E. F.; French, K. R. (2015). “A Five-Factor Asset Pricing Model”. Journal of Financial Economics. 116: 1-22.

What is claimed is:

1. A computer-based method to build, store, and provide access to a business/enterprise model, wherein the method may include identifying at least two business/enterprises that have one or more relationships between them.

2. The method according to claim 1, wherein the method constructs the said model as a computer data structure, including but not limited to graphs, tables, and databases, capable of handling entities and relationships. Entities include, but not limited to companies, enterprises, businesses, persons, commodities, and regions. Relationships include, but not limited to, suppliers, partners, customers, competitors, substitute providers, disruptors, and competitors.

3. The method according to claim 2, wherein the method constructs the said model using Natural Language Processing on media such as, but not limited to speech, images, videos, and text, from sources, including but not limited to, company reports, PR Newswire, Social and News media, earnings calls, company websites, and videos.

4. The method according to claim 2, wherein the method allows augmentation of the model with information from third party networks including, but not limited to, Facebook and Linkedin.

5. The method according to claim 2, wherein the method exposes the model including the entities and the relationships to the users, experts, and the marketplace.

6. The method according to claim 2, wherein the method lets users, experts, and marketplace add new entities and relationships or modify existing ones.

7. The method according to claim 2, wherein the method computes and assigns a metric related to the strength of the relationships.

8. The method according to claim 7, wherein the method lets the users, experts, and marketplace modify the system assigned metric for the strength of the relationships.

9. The method according to claim 2, wherein the method captures changes to the model over a period of time or any other metric of relevance.

10. A computer-based method to perform analysis of assets, predict the future prices of assets, provide recommendations, and perform actions, wherein the method may include analyzing and forecasting the performance of at least one said asset against one or more said impacting assets.

11. The method according to claim 10, wherein the computer running the method can be on a customer's own server or hosted on a cloud server.

12. The method according to claim 10, wherein the inputs to the method could be assets of any combination of structured data, unstructured data, user defined data etc.

13. The method according to claim 12, wherein the user can bring their own data to be used by the method, in addition to the system provided data.

14. The method according to claim 13, wherein the method provides a data marketplace so that users can buy and/or sell data for use by the said method or for any other use the user deems appropriate.

15. The method according to claim 13, wherein the user data is isolated in data enclaves and data lakes for security and privacy.

16. The method according to claim 13, wherein the method encrypts the data for security and privacy.

17. The method according to claim 12, wherein the structured data includes, but not limited to, any combination of stocks and bond prices, commodity prices, company fundamentals, social media sentiments, suppliers, customers, partners, competitors, economic and monetary indicators, health and demographic data, weather data, consumer sentiment, etc. Company fundamentals include, but not limited to, revenue, income, profit, loss, and capital expenses. Economic and monetary indicators include, but not limited to, GDP, inflation, interest and mortgage rates, etc. Unstructured data include, but not limited to, social media, news reports, consumer reviews, media, analyst reports, discussion forums, user manuals, service and parts manuals, company annual reports, PR Newswire, etc.

18. The method according to claim 17, wherein the method allows the user to select the inputs individually or by group, if desired.

19. The method according to claim 18, wherein the method allows filtering and grouping of inputs according to an industry defined taxonomy of categories and subcategories.

20. The method according to claim 19, wherein the method allows users to override the industry defined taxonomy of categories and subcategories.

21. The method according to claim 18, wherein the method uses natural language processing (NLP) techniques for unstructured data.

22. The method according to claim 21, wherein the method uses NLP to convert unstructured data into structured data for further processing in cases where appropriate or to convert unstructured data into predictions after appropriate conversion of the data using one of the weights or ranks deduced by the method which could be overridden by the user.

23. The method according to claim 18, wherein the inputs are further processed automatically by the system using techniques that include, but not limited to, normalization, scaling, homogenization, automatic recognition and formatting of data fields, and filling of missing values using a variety of statistical and machine learning techniques.

24. The method according to claims 1 and 23, wherein the method assesses the inputs and the business/enterprise model from claim 1 to assign a metric related to the inputs' importance to any given asset.

25. The method according to claim 24, wherein the method enables the users to modify the system assigned metric for the inputs' importance to any given asset.

26. The method according to claim 25, wherein the method automatically ranks the inputs.

27. The method according to claim 26, wherein the method enables the users to modify the system's ranking of the inputs.

28. The method according to claim 27, wherein the method uses the ranked inputs to perform several types of analysis including, but not limited to, what if analysis, impact analysis, risk analysis, causation analysis, correlation analysis, etc.

29. The method according to claim 27, wherein the method predicts the future values of the inputs for an arbitrary period.

30. The method according to claim 28, wherein the method predicts the future asset prices for an arbitrary period.

31. The method according to claims 29 and 30, wherein the method allows the user to select the prediction period.

32. The method according to claims 29 and 30, wherein the method predicts the future values with confidence intervals or bands.

33. The method according to claim 32, wherein the method allows the user to filter and set the bar for these confidence intervals or bands.

34. The method according to claims 29 and 30, wherein the method predicts using custom, predefined, and user-defined algorithms.

35. The method according to claim 32, wherein the method allows the user to bring their own algorithms.

36. The method according to claim 34, wherein the method's prediction techniques, include, but not limited to, statistical, machine learning, and natural language processing on structured and unstructured data.

37. The method according to claim 29, wherein the method allows the user to modify the system predicted values.

38. The method according to claims 27 and 30, wherein the method predicts the future asset prices by using the current and past values of the inputs.

39. The method according to claims 30 and 37, wherein the method predicts the future asset prices by using the future values of the inputs.

40. The method according to claims 30 and 37, wherein the method predicts the future asset prices by using the past, current, and future values of the inputs.

41. The method according to claim 34, wherein the method automatically identifies the best prediction technique based on a target criterion (such as Mean Square Error) defined by the system or the user.

42. The method according to claim 41, wherein the user of the method can override the said method's recommendation of the prediction technique.

43. The method according to claim 10, wherein the method makes recommendations based on analysis and predictions.

44. The method according to claim 43, wherein the said method's recommendations are based on, but not limited to, users' preferences, constraints, compliance restrictions and profile (such as current income, age, risk appetite, ability to short sell securities, restrictions in operating in certain markets etc.)

45. The method according to claim 43, wherein the said method's recommendations include buying, selling, hedging of one or more assets.

46. The method according to claim 43, wherein the user of the said method is allowed to accept, modify, or reject one or more system's recommendations or add new ones to the list of system's recommendations.

47. The method according to claim 10, wherein the method takes actions based on the recommendations on behalf of the user.

48. The method according to claim 47, wherein the method's actions are atomic or split into sub-actions.

49. The method according to claim 48, wherein the method's actions can be instantaneous or scheduled ahead.

50. The method according to claim 49, wherein the method's the users can override or modify the said method's actions or add new ones.

51. The method according to claim 10, wherein the method uses natural user interface.

52. The method according to claim 51, wherein the method provides interactivity through various medium including, but not limited to, mobile, PC, and tablet, and accepts user gestures including, but not limited to, voice commands, keyboard input, and OCR.

53. The method according to claim 10, wherein the method integrates with third party systems.

54. The method according to claim 53, wherein the method accepts inputs and shares the analyses, predictions, recommendations, and actions with other users and systems on demand.

55. The method according to claim 10, wherein the method operates all aspects of the system autonomously without user intervention over a period of time.

56. The method according to claim 55, wherein the method's autonomous operations can be interrupted any time by the user.
